(19) United States
(12) Patent Application Publication
(10) Pub. No.: US 2020/0184344 A1
(43) Pub. Date: Jun. 11, 2020

(54) SYSTEM AND METHOD FOR MEASURING MODEL EFFICACY IN HIGHLY REGULATED ENVIRONMENTS

(71) Applicant: MORGAN STANLEY SERVICES GROUP INC., New York, NY (US)

(72) Inventors: Michael A. DOBROVOLSKY, New York, NY (US); Dustin L. HILLARD, Seattle, WA (US); Pankaj PARASHAR, Jersey City, NJ (US); Nora E. BARRY, New York, NY (US)

(21) Appl. No.: 16/213,203

(22) Filed: Dec. 7, 2018

(51) Int. Cl. G06N 5/02; G06F 16/2455; G06Q 30/06

(52) U.S. Cl. CPC G06N 5/02; G06Q 30/0631; G06F 16/2455

(57) ABSTRACT

Systems and methods for measuring efficacy of prediction models are described. A processor generates champion scores, variation scores, and challenger scores based on data analyzed using a champion model and a challenger model. The processor uses the variation scores to define a control group and a test group based on the relationship of the variation scores to the champion scores and the challenger scores. The control group and test group are measured to determine an attributable impact on completed actions and based on the attributable impact, one of the champion model and challenger model is selected.

### FIELD OF THE INVENTION

The present invention relates generally to the testing and updating of machine learning models used in highly regulated areas where regulation significantly limits how control groups and test groups may be defined.

### BACKGROUND

Artificial intelligence systems employing sophisticated machine learning models are revolutionizing business worldwide, even in highly regulated industries such as finance or banking. In the banking and finance contexts, machine learning models can be used, for example, to predict client behaviors. The predicted client behaviors can be used in turn to advise the clients. As updates or enhancements to the models are developed, it is important to understand and measure the impact of such updates on a target population and to test the updated models in comparison with existing models. This understanding is essential to avoid risk and to maximize the efficiency and impact of the model enhancements.

One method of testing an updated model is known as A/B testing, whereby the target population is first divided into two groups, A and B, in an unbiased approach such as random selection. An existing model and an updated model are then applied to the A and B groups, respectively. The output of the models for both populations are then compared to validate that the new model is producing an improved or otherwise desired result.

In the case of strictly regulated environments such as finance and banking, the existing model is often used to produce financial gain for the client. Due to regulations, control groups and test groups cannot be defined in a way that might put one group at a disadvantage to another. Therefore, in its conventional form, A/B testing usually cannot be applied to test enhancements of models employed in such strictly regulated environments because either of the A and B groups may be placed at a disadvantage relative to each other by virtue of the testing.

Accordingly, there is a need for an improved system and method for testing models in which members of a target population are not put at a disadvantage relative to other members of the target population.

### SUMMARY

According to one embodiment, the invention relates to a computer-implemented system for measuring prediction model efficacy. The system can provide an improved ability to test new or updated models in highly regulated environments such that no member of a target population on which the testing is conducted is placed at a disadvantage. According to one embodiment, the system includes a database in communication with a network and a processor in communication with the network. The processor may be configured to retrieve a dataset from the database, the dataset including identifying information for a plurality of targets, one or more predicted actions, and completed actions for each of the plurality of targets. The system may be applied in environments where clients of financial institutions are considered the targets and buying or selling specified financial instruments are considered the actions. The processor may be further configured to associate each of the plurality of targets with the one or more predicted actions to create target-action pairs. The processor may be further configured to, for each target-action pair, generate a champion score using a champion model and, for each target-action pair, generate a variation score using the champion model. The variation score may be selected from a distribution of scores existing within a first confidence interval. The processor may also, for each target-action pair, generate a challenger score using a challenger model. Additionally, the processor may define a test group comprising one or more target-action pairs for which the variation score is within a second confidence interval of the challenger score and define a control group comprising of one or more target-action pairs for which the variation score is within a third confidence interval of the champion score. Based on an accuracy of the control group to the completed actions and an accuracy of the test group to the completed actions, the processor may select one of the champion model and challenger model.

According to another embodiment, the invention relates to a method including the steps of: (1) retrieving a dataset from a database, the dataset including a plurality of targets, one or more prediction variables, and measured actions for each of the plurality of targets, (2) associating each of the plurality of targets with the one or more prediction variables to create target-variable pairs, (3) for each target-variable pair, generating a champion score using a champion model, (4) for each target-variable pair, generating a variation score using the champion model, wherein the variation score is selected from a distribution of scores generated by the champion model existing within a first confidence interval, (5) for each target-action pair, generating a challenger score using a challenger model, (6) defining a test group comprising one or more target-action pairs for which the variation score is within a second confidence interval of the challenger score, (7) defining a control group comprising of one or more target-action pairs for which the variation score is within a third confidence interval of the champion score, (8) selecting one of the champion model and challenger model based on an accuracy of the control group to the completed actions and an accuracy of the test group to the completed actions, (9) executing, by a processor, one of the champion model and challenger model based on step (8).

Exemplary embodiments of the invention can thus provide effective testing and selection of a new, updated model relative to an established model without placing members of the target population for the models at a disadvantage relative to each other.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a system for measuring model efficacy according to an exemplary embodiment of the invention.

FIG. 2 illustrates a block diagram of a model engine according to an exemplary embodiment of the invention.

FIG. 3 illustrates a prediction model process flow according to an exemplary embodiment of the invention.

FIG. 4 illustrates a process flow for measuring model efficacy according to an exemplary embodiment of the invention.

FIG. 5 illustrates an example of a process flow for measuring model efficacy according to an exemplary embodiment of the invention.

FIG. 6 illustrates an example of a process flow for attribution according to an exemplary embodiment of the invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

According to one embodiment, a system for measuring prediction model efficacy is provided in which a challenger model is tested against a champion model without placing members of a target population at a disadvantage relative to each other.

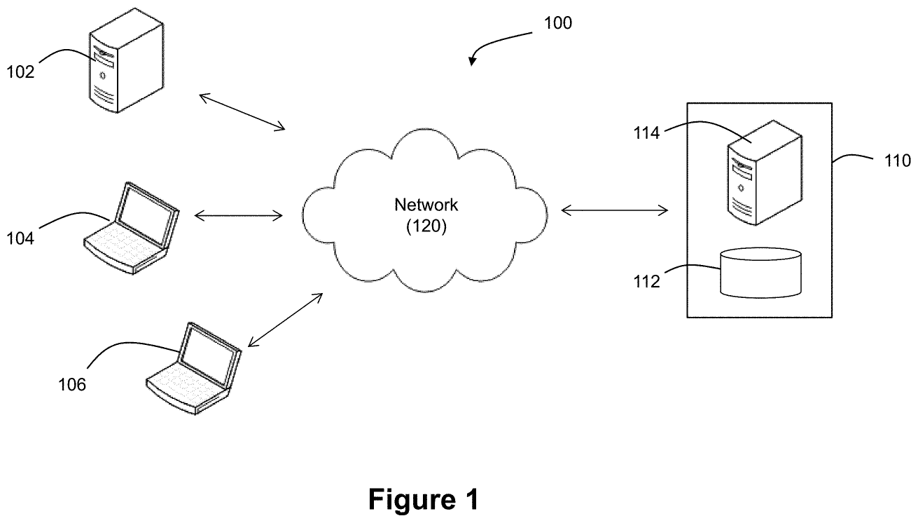

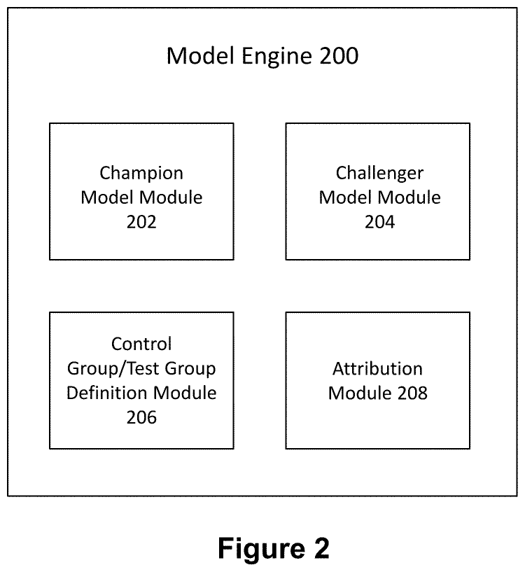

One embodiment of the system is shown in FIG. 1. The system 100 includes a model server 102 which is connected to a network 120. The model server 102 includes a central processing unit (CPU) and memory for storing instructions executable by the CPU. The model server 102 contains and runs a model engine responsible for executing statistical modeling, including predictive modeling, based on various data inputs. The model engine is described further herein with reference to FIG. 2.

The network 120 may comprise any one or more of the Internet, an intranet, a Local Area Network (LAN), a Wide Area Network (WAN), an Ethernet connection, a WiFi network, a Global System for Mobile Communication (GSM) link, a cellular phone network, a Global Positioning System (GPS) link, a satellite communications network, a data bus, or other network, for example.

The system 100 also includes a database 110 which may include an associated database server 114 and a storage medium 112. In the case of a very large organization having very large amounts of data, the database 110 may include multiple servers and multiple storage media. The database is configured to store data input to and analyzed by statistical models on the model server 102. The data that is input to and analyzed by statistical models generally includes what are referred to herein as targets and variables. As described in the examples provided, where the system 100 is used by a financial institution, for example, database 110 may store data which includes client information about clients (examples of targets) and predicted or suggested actions (examples of variables). Client information may include, but is not limited to, an account identification number, account balance, account asset allocation, personal information, etc. Predicted or suggested actions may be actions based on research by or identified by analysts of the financial institution. The database 110 may further store data reflecting actions completed by clients such as deposits, withdrawals, purchases of financial instruments, etc. The database 110 may be continuously updated with such data.

The system 100 also includes user terminals 104 and 106 which may comprise a desktop computer, laptop computer, tablet computer, smart phone, or other personal computer and which is connected to the network 120. The user terminals 104 and 106 include a display on which a graphical user interface (GUI) is shown to a user.

FIG. 2 is a diagram illustrating a model engine 200 which is contained and run by the model server 102 described above. The model engine 200 includes a champion model module 202 which is configured to analyze input data relating to a target population using a champion model, where the champion model is an existing, or currently accepted model. The champion model 202 may generate, for example, a champion score based on the input data.

The model engine 200 further includes a challenger model module 204 which is configured to analyze input data relating to the target population using a challenger model, which is introduced for comparison to the champion model. The challenger model may be an updated or enhanced version of the champion model or may be an entirely distinct model. The challenger model 204 may generate, for example, a challenger score based on the input data.

The model engine 200 further includes a Control Group/Test Group Definition Module 206 which is configured to define a control group and a test group for the purpose of measuring the efficacy of the challenger model in relation to the champion model. In highly regulated environments, such as banking and finance, it is often the case that the control group and the test group cannot be defined in such a manner that puts either group at a disadvantage to the other, such as when the groups consist of clients of a financial institution. As a result, it is also often the case that the control group and the test group cannot be defined such that the champion model is simply applied to the control group and the challenger model is applied to the test group because one of the models is likely produce less favorable results for one of the groups.

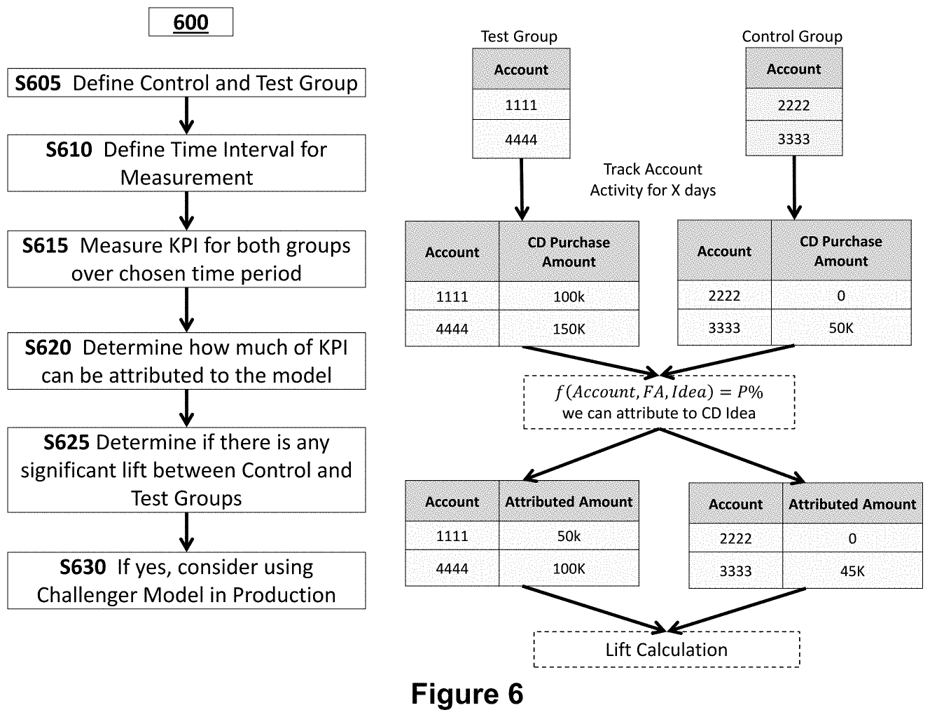

The model engine 200 further includes an attribution module 208 configured to measure the impact on Key Performance Indicators (KPI) for the control group and the test group. Specifically, the attribution module 208 serves to measure what impact on any given KPI is attributable to the output of the challenger model. When the attribution module 208 determines that the output of the challenger model has an improved impact on one or more KPIs, it may determine that the challenger models should be implemented in lieu of the champion model. The configuration of the attribution module 208 is discussed in greater detail below with reference to FIG. 6.

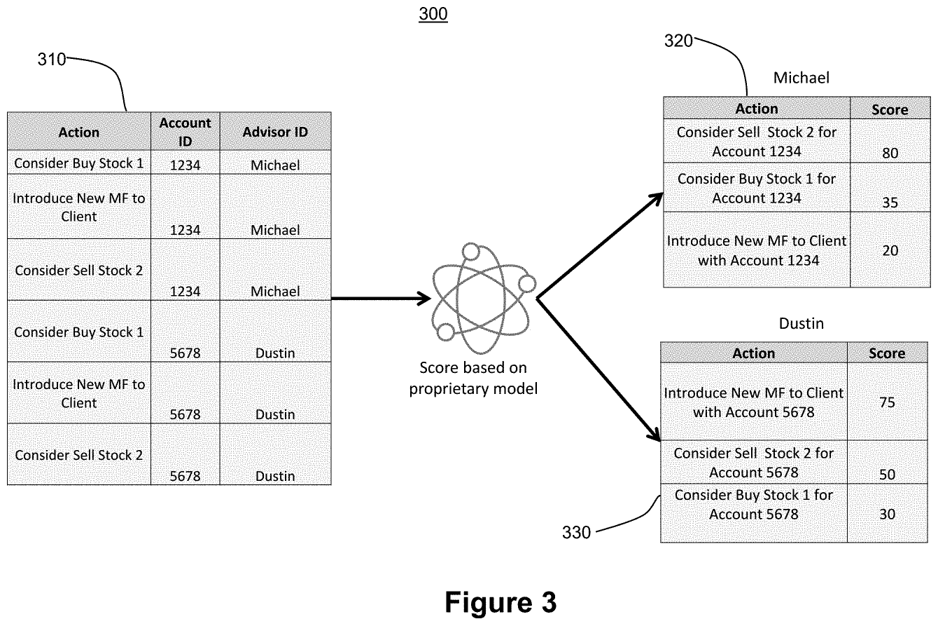

FIG. 3 illustrates an example analysis of a prediction model in a financial context. In the example, there is no challenger model. Table 310 consists of various data to be input to a proprietary prediction model. In the “Action” column three different actions are presented. A first action is a recommendation to buy Stock 1. A second action is introducing a new mutual fund to the client. A third action is a recommendation to sell Stock 2.

In the “Account ID” column, numbers 1234 and 5678 are shown and are representative of distinct accounts which may be held by distinct clients. Each of the client-held accounts 1234 and 5678 is assigned an advisor. The advisors are listed in the “Advisor ID” column and are identified as Michael and Dustin, where Michael is associated with account 1234 and Dustin is associated with account 5678.

The data shown in table 310 is analyzed by a proprietary model which generates scores. Scores generated by the proprietary model for account 1234 assigned to Michael are shown in table 320 whereas scores for account 5678 assigned to Dustin are shown in table 330. In the example, the data in each row of table 310 are associated with each other and one score is generated for each row.

Specifically, the score generated for the first row of data in table 310 is shown in the second row of table 320 and is a score of 35. The score generated may be on a numbered scale or may be on any other suitable scoring scale. Similarly, the score generated for the second row of data in table 310 is shown in the third row of table 320 and is a score of 20. The score generated for the data in the third row of table 310 is shown in the first row of table 320 and is a score of 80.

The score generated for the fourth row of data in table 310 is shown in the third row of table 330 and is a score of 30. The score generated for the fifth row of data in table 310 is shown in the first row of table 330 and is a score of 75. The score generated for the data in the sixth row of table 310 is shown in the first row of table 320 and is a score of 80.

In the example of FIG. 3, the proprietary model may generate prediction scores which are predictive of the likelihood of a particular action occurring. For example, the three data points of the first row of table 310 which are input to the proprietary model may be representative of financial advisor Michael advising the holder of account number 1234 to buy Stock 1. The proprietary model may generate a score that is representative of the likelihood that the holder of account number 1234 will buy Stock 1 according to Michael's advice, which in this instance is 35 and is shown in the second row of table 320. The holder of account 1234 is less likely to buy Stock 1 according to Michael's advice (score of 35) than she is to sell Stock 2 according to Michael's advice (score of 80) and is less likely to buy the new Mutual Fund according to Michael's advice (score of 20) than she is to buy Stock 1.

Table 330, on the other hand, shows three different scores, which may indicate, for example, that the holder of account 5678 receiving Dustin's advice has a different likelihood of buying the new Mutual Fund, selling Stock 2, and buying Stock 1 than does the holder of account 1234 according to Michael's advice.

The advisors, Michael and Dustin, may use the scores generated by the proprietary model and set forth in table 320 and 330 to determine the order in which the information is provided to the holders of the account. For example, because the holder of account 1234 is most likely to sell Stock 2, Michael may provide that recommendation first, followed by a recommendation to buy Stock 1 and ultimately a recommendation to buy the new Mutual Fund. In this way, the scores generated by the proprietary model serve to indicate to the advisors what is most important to the account holders so that recommendations can be made in accordance with the account holders' preferences.

It is noted that while the scores set forth in table 320 differ from the scores set forth in table 330, each of the holder of account 1234 and the holder of account 5678 receives the same three recommendations from advisor Michael and advisor Dustin, respectively. In a highly regulated environment, such as finance or banking, advisors may be required to provide the same material information to each account holder such that no account holder is put at a disadvantage with respect to another account holder. Therefore, the scores generated by the proprietary model allow the advisors to present the same information to each account holder, thereby operating within applicable rules and regulations, while presenting the information to each account holder in the most preferable order.

As a result of the restraints imposed by regulations, it is difficult to test proposed updates to a proprietary model such as the model of FIG. 3. An updated model may not, for example, be tested in such a way that the holder of account 1234 receives materially different recommendations than the holder of account 5678.

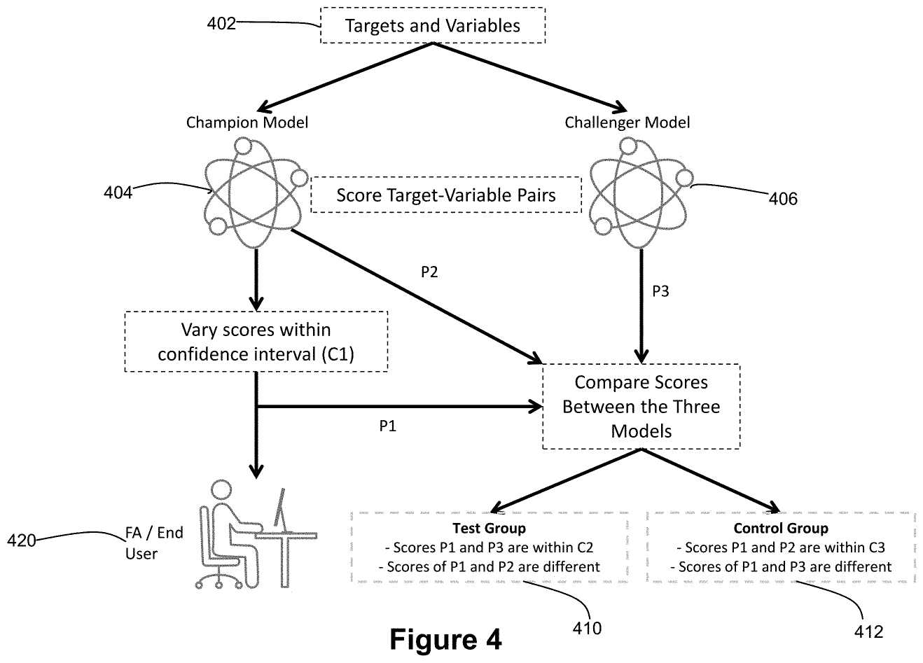

Accordingly, a method of testing proposed updates to a model which does not place any members of a target population of the model (such as account holders) at a disadvantage relative to other members is proposed and an example of such a method is described with reference to FIG. 4.

In FIG. 4, a set of targets and variables 402 is used as an input. The targets may be accounts, account holders, or any other member of a population for which the application of a statistical model may be useful. The variables may be actions which can be suggested, for example, by a financial advisor or other advisor, and carried out by the target. Examples of variables which are actions may include buying or selling financial instruments but need not be financial in nature and may encompass reviewing non-financial documents, reviewing news articles, etc. Variables need not be actions either and instead can be anything for which the application of a statistical model may be useful.

The set of targets and variables 402 is input to both a champion model 404 and a challenger model 406. The champion model 404 is an existing model that is in use and the challenger model 406 is a model being tested against the champion model 404. The challenger model 406 may be an updated version of the champion model 404 or may be a completely new model.

When the set of targets and variables 402 is input to the models, targets and variables are paired together in one or more target-variable pairs. For example, in a set having five targets and two variables, as many as ten target-variable pairs may be created such that each possible combination of targets and variables is created. However, less than ten target-variable pairs may be created if a particular dataset requires analysis of less than every combination of target-variable pairs. Additionally, in certain modeling scenarios, targets may be matched with more than one variable. For simplicity of explanation, modeling in which target-variable pairs consist of one target and one variable will be described.

When the set of targets and variables 402 is input to the champion model 404, for the purpose of testing the challenger model 406, the champion model 404 generates two sets of prediction scores for the target-variable pairs. The prediction scores may be numbered on a scale, for example, or may be letter grades or another suitable scoring method.

When used in an ordinary course to generate prediction scores, as opposed to testing the challenger model 406, the champion model 404 may generate a single score for each target-variable pair representing a prediction for that target-variable pair. That score may be generated by a statistical process that essentially samples the mean from a distribution of potential scores. A set of scores generated in the ordinary course by the champion model 404 (ordinary scores) may be represented by the following formula:

\hat{p}=f(x₁, . . . , xₙ).

In the scenario shown in FIG. 4 where the champion model 404 is being used to test the challenger model 406, variation is introduced to the ordinary scores generated by the champion model 404 such that a set of prediction scores P1 is generated. Variation is introduced by sampling from the distribution of potential scores based on a confidence interval C1 that characterizes the distribution of the champion model 404's predictions:

[symbol]

= [symbol] f (x₁, . . . , xₙ)

[symbol]

This confidence interval can be determined by measuring prediction error for input data that has been held out of the modeling analysis, or directly produced by a modeling technique that can directly predict a distribution of values (rather than a single value).

The champion model 404 also generates a set of prediction scores P2 which is a set of ordinary scores without the variation introduced for the set of prediction scores P1.

When the set of targets and variables 402 is input to the challenger model 406, the challenger model 406 generates a set of prediction scores P3 for the target-variable pairs. The scores in the set of prediction scores P3 is preferably in the same format as each of the sets of prediction scores P1 and P2.

Once the sets of prediction scores P1, P2, and P3 are generated by the champion model 404 and the challenger model 406, the scores are sorted into a control group and test group for the purpose of evaluating the challenger model 406 against the champion model 404. Because it is assumed that no target among the set of targets and variable 402 can be disadvantaged in the testing by virtue of regulation or another reason, the control group and test group must be arranged such that no targets are disadvantaged. Accordingly, the test group and control group are each comprised of scores from the set of prediction scores P1.

To determine which scores from P1 are in the test group 410 and which are in the control group 412, scores from P1, P2, and P3 for each target-variable pair are compared. For individual target-variable pairs having a prediction score in the set P1 within a confidence interval C2 of its corresponding prediction score in the set P3 and different from its corresponding prediction score in the set P2, the scores from the set P1 are placed in the test group 410. For individual target-variable pairs having a prediction score in the set P1 within a confidence interval C3 of its corresponding prediction score in the set P2 and different from its corresponding prediction score in the set P3, the scores in the set P1 are placed in the control group 412. The confidence intervals C2 and C3 are defined to specify the acceptable range of prediction scores to consider when evaluating the champion and challenger models. The interval C2 can be used to adjust the sensitivity of what predictions P1 are considered close enough to challenger predictions P3 to be included in the test group. Similarly, the interval C3 can be used to adjust the sensitivity of what predictions P1 are considered close enough to champion predictions P2. The scores in the set P1 that comprise the control group can be summarized by the following equation:

$$\hat{p} = \{ \begin{matrix}{p}_{test} , & {p}_{1} - {p}_{3} < C 2 \\ {p}_{control} , & {p}_{1} - {p}_{2} < C 3\end{matrix}$$

Ultimately, the prediction scores from the set P1 are received by an end user 420 which may be a financial analyst, for example. The end user therefore is provided with a set of prediction scores generated by the champion model 404 with variation introduced in a way that the scores still exist within an acceptable confidence interval C1. Thus, if the financial analyst uses the scores to make recommendations to clients, the recommendations will all be made based on the scores of the champion model 404 within the acceptable confidence interval, regardless of which client is being advised, and therefore no client is placed at a disadvantage.

In this manner, the variation introduced to the set of prediction scores P1 by sampling a prediction score for a large number of predictions generates increased diversity in scores and allows for testing outcomes that would not be otherwise observed. Given the broader diversity of prediction scores, the challenger model 406 can be assessed by observing the outcome for predictions in the set of prediction scores P1 that are more similar to the mean of the scores generated by the challenger model 406, i.e., the set of prediction scores P3, without exceeding the boundaries of scores that may be generated by the champion model 404.

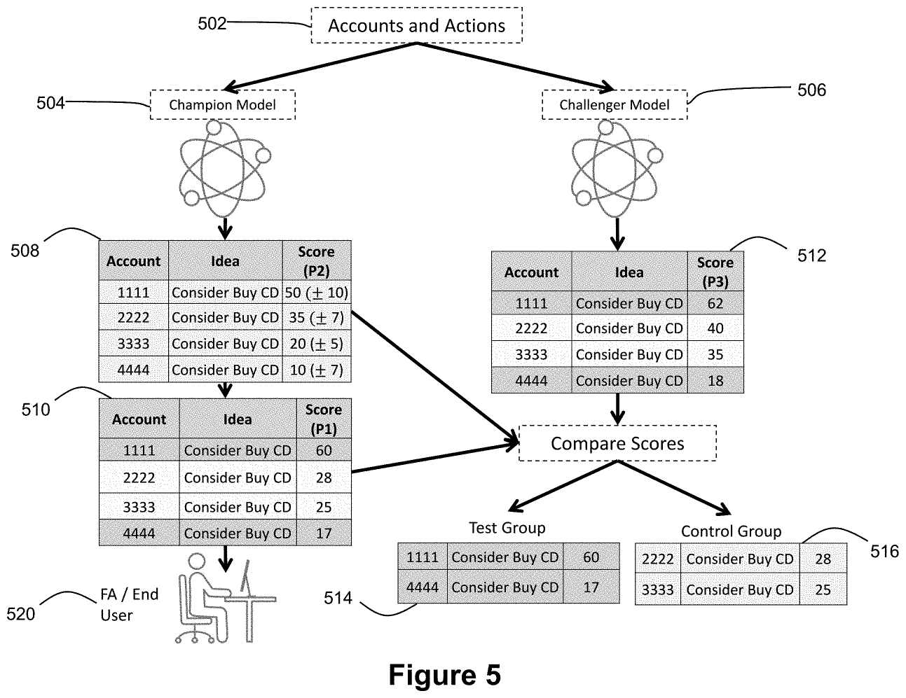

An example of the method described above will be described with reference to FIG. 5. FIG. 5 shows an application of the method in the context of a financial advisor using statistical models to advise clients. In the example, the input data comprises a set of accounts and actions 502, where the accounts are comparable to targets and the actions and are comparable to variables. The set of accounts and actions 502 includes four accounts numbered 1111, 2222, 3333, and 4444, and one action Consider Buy CD, where the CD is a certificate of deposit, i.e. a financial instrument.

The set of accounts and actions 502 is input to both a champion model 504 and a challenger model 506. The champion model 504 is an existing model that is in use, for example, as a tool for a financial advisor to use when advising clients, and the challenger model 506 is a model being tested against the champion model 504. The challenger model 506 may be an updated version of the champion model 504 or may be a completely new model.

When the set of accounts and actions 502 is input to the models, accounts and actions are paired together in one or more account-action pairs. In the example, there are four accounts and one action so four account-action pairs are created. The champion model 504 then generates two sets of prediction scores for each of the account-action pairs.

One set of prediction scores P1 generated by the champion model 504 is shown in table 510. The set of prediction scores P1 are generated by the champion model 504 with variation introduced such that the scores fall within a confidence interval as in the example above. Table 510 shows that for Consider Buy CD paired with account 1111, the champion model 504 generates a score of 60 with the variation introduced. Likewise for accounts 2222, 3333, and 4444, the champion model 504 generates scores of 28, 25, and 17 respectively.

Table 508 shows another set of prediction scores P2 for the account-action pairs generated by the champion model. As in the example above, the scores in table 508 are the ordinary scores generated by the champion model 504 and are shown with their respective confidence intervals. For example, the champion model 504 generates an ordinary score of 50 for Consider Buy CD paired with account 1111. The score of 50 has a confidence interval of +/−10 meaning the score will fall between 40 and 60 a predetermined percentage of times the champion model 504 is run. Table 508 additionally shows that for accounts 2222, 3333, and 4444, the champion model 504 generates scores of 35 (+/−7), 20 (+/−5), and 10 (+/−7), each shown with their respective confidence intervals in parentheses. Each of the scores in the set P1 shown in table 510 falls within the confidence interval of the set P2 shown in table 508.

Additionally, a set of prediction scores P3 generated by the challenger model 506 for each of the account-action pairs is shown in table 512. Specifically, table 512 shows that for account 1111, 2222, 3333, and 4444, the scores generated by the challenger model 506 for Consider Buy CD are 62, 40, 35, and 18 respectively.

Once the sets of prediction scores P1, P2, and P3 are generated by the champion model 504 and the challenger model 506, the scores are sorted into a control group and test group for the purpose of evaluating the challenger model 506 against the champion model 504. Because it is assumed that no account among the set of accounts and actions 502 can be disadvantaged in the testing by virtue of regulation or rule, the control group and test group must be arranged such that no accounts are disadvantaged. Accordingly, the test group and control group are each comprised of scores from the set of prediction scores P1.

To determine which scores from P1 are in the test group 514 and which are in the control group 516, scores from P1, P2, and P3 for each account-action pair are compared. For account 1111 paired with Consider Buy CD, the score in the set P1 of 60 is within a confidence interval C2 of the score in the set P3 of 62. Similarly, for account 4444 paired with Consider Buy CD, the score in the set P1 of 17 is within a confidence interval C2 of the score in the set P3 of 18. These scores from the set P1 are placed into the test group 514.

The scores in the test group 514 are generated by the champion model 504 and exist within the confidence interval of the scores in the set P2. However, they are close to the mean scores shown in the set P3 and are therefore effective for use in testing the challenger model 506 which generated the scores in the set P3.

The remaining scores for accounts 2222 and 3333 in the set P1 each fall outside the confidence interval C2 of the corresponding scores in the set P3. These scores are therefore used as the control group.

Ultimately, the prediction scores from the set P1 are received by an end user 520 which may be a financial analyst. The end user therefore is provided with a set of prediction scores generated by the champion model 504 with variation introduced in a way that the scores still exist within an acceptable confidence interval C1. Thus, if the financial analyst uses the scores to make recommendations to clients, the recommendations will all be made based on the scores of the champion model 504 within the acceptable confidence interval, regardless of which client is being advised, and therefore no client is placed at a disadvantage. In this manner, account 1111 is not placed at a disadvantage with respect to account 2222, or vice versa, because scores leading to recommendations by the financial analyst 520 were generated by the same champion model 504 and fall within an appropriate confidence interval.

Following assignment of the scores in the set P1 to the test group and control group, the test group and control group are analyzed to determine the effectiveness of the challenger model. A method for comparing the test group to the control group will be described with reference to the method 600 shown in FIG. 6. The steps in FIG. 6 are shown using the same input data, i.e., the accounts and action, of FIG. 5.

First, in step S605, the control group and test group are defined as described above. In the example, the test group comprises the scores from the set P1 for accounts 1111 and 4444 whereas the control group comprises the scores from the set P1 for accounts 2222 and 3333.

In step S610, a time interval is defined. The time interval represents the amount of time that real data corresponding to the prediction scores will be tracked. In the example, the time interval may be a number of days that account activity is tracked for each of the accounts 1111, 2222, 3333, and 4444.

After the test and control groups are defined and the time interval for measurement is defined, one or more appropriate Key Performance Indicators (KPIs) are measured in step S615 to determine the efficacy of the challenger model. KPIs that consider one prediction at a time can be directly assessed and are represented by the following equation:

KPIₜₑₛₜ=Σ_{each p} KPI(Pₜₑₛₜ)

where pₜₑₛₜ is the predicted actions within the test group.

In certain situations, a KPI of interest may require aggregation across multiple individual prediction scores. For example, measuring an impact on a customer or account may require assessment of multiple individual prediction scores generated for that customer or account.

In the example, the KPI used is an amount of the CD purchased. As shown, $100k of the CD was purchased for account 1111 and $150k of the CD was purchased for account 4444. Also, $0 of the CD was purchased for account 2222 while $50k was purchased for account 3333. These are amounts of the CD purchased within the defined time interval following application of the scores in the set P1 generated by the champion model. The application in the example may be that the financial advisor used the scores to recommend buying the CD in certain amounts.

In step S620, an amount of the KPI attributable to the model is determined. This is an amount that can be considered to be influenced by the model. In the example, attribution accounts for the amount of the CD purchased as a direct result of the score in the set P1 generated by the champion model and used as a basis for a recommendation by the financial adviser, distinguished from amounts of the CD purchased that would have been purchased without the influence of the model.

When determining attribution, the impact on a KPI can be evaluated by weighting the impact of individual predictions using an attribution model. The attribution model differs depending on the KPI and application, but can generally be considered to provide a measure of the impact an individual prediction has at an aggregated level. An equation representing the impact on a KPI is as follows:

KPl_{customer}=Σ_{customer} wₐₜₜᵣ* KPI (p)

where wₐₜₜᵣ is the weighted impact of each individual prediction.

When prediction variation is introduced, as described above, the attribution model may be utilized to separate the impact of the control and test group predictions. The following is an equation showing the overall customer KPI impact as a function of the test group scores and the control group scores:

KPi_{cust}=Σ_{cust} wₐₜₜᵣ* KPI(pₜₑₛₜ)+wₐₜₜᵣ* KPI(p_{control})

where pₜₑₛₜ are the predicted actions of the customer that fell under the test group and p_{control} are the predicted actions that fell under the control group.

The KPI impact from the scores in the test group can be measured based on attribution of just the test group scores:

KPI_{cust_test}=Σ_{cust} wₐₜₜᵣ* KPI(pₜₑₛₜ)

Additionally, KPI impact can also be measured for just the scores in the control group:

KPI_{cust_control}=Σ_{cust} wₐₜₜᵣ* KPI(p_{control})

After measuring KPI impact for the prediction scores within the test group and control group, in step S625 the attributed KPI impact amounts are compared to determine whether this is a significant lift between the control and test groups. In the example, the prediction scores in the test group resulted in $50k and $100k purchases of the CD attributable to the test scores. In comparison, the prediction scores in the control group resulted in $0 and $45k purchases of the CD attributable to the control scores.

If a significant lift is determined to exist between the test group and the control group, a determination may be made on the efficacy of the challenger model. Improved KPIs in the test group can justify roll out of the test model, resulting in improved outcomes across populations. In the example, if larger quantities of CD purchased per account is considered an improved KPI, the higher amounts attributable to the scores in the test group may justify implementation of the challenger model. Given a significant lift is determined on the desired KPI in testing, the challenger model can be automatically promoted to become the new production champion model.

The method described above for testing new or updated statistical models provides a solution for testing in a strictly regulated environment. Specifically, the strategy employs variation in an existing model (a champion model, for example) to achieve acceptable prediction scores which simulate prediction scores by an updated model (or challenger model). Using this method, the challenger model can be effectively tested without directly applying it to any members of the target population, thereby protecting the members of the target population from any disadvantage inherent in applying different models. A champion model is used and applied to each member of the target population in a fair way which also allows testing of a challenger model. The methodology improves the ability of to measure statistical systems without bias, and identify superior models for customer deployment.

Moreover, the method allows statistical models running on computer hardware to be updated and tested against a prevailing model. A system employing the method can fairly test the updated model on a live population and automatically determine whether the updated model is an improvement over the prevailing model and whether implementation of the updated model should be carried out. The method may be used in a machine learning or neural network environment to automatically teach a system to improve and implement its statistical models.

Those skilled in the art will appreciate that the diagrams discussed above are merely examples of a system for measuring model efficacy and are not intended to be limiting. Other types and configurations of networks, servers, databases and personal computing devices (e.g., desktop computers, tablet computers, mobile computing devices, smart phones, etc.) may be used with exemplary embodiments of the invention. Although the foregoing examples show the various embodiments of the invention in one physical configuration; it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. The components of the various embodiments may be arranged at any location or locations within a distributed network without affecting the operation of the respective system.

Although examples of servers, databases, and personal computing devices have been described above, exemplary embodiments of the invention may utilize other types of communication devices whereby a user may interact with a network that transmits and delivers data and information used by the various systems and methods described herein. The user terminals 104 and 106 may include desktop computers, laptop computers, tablet computers, smart phones, and other mobile computing devices, for example. The servers, databases, and personal computing devices may include a microprocessor, a microcontroller or other device operating under programmed control. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art. The personal computing devices may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The personal computing devices may also include a network-enabled appliance or another TCP/IP client or other device. Although FIG. 1 shows a limited number of personal computing devices, in practice other personal computing devices will typically be used to access, configure and maintain the operation of the various servers and databases shown in FIG. 1.

The servers, databases, and personal computing devices described above may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software. The modules described above may comprise software stored in the memory (e.g., non-transitory computer readable medium containing program code instructions executed by the processor) for executing the methods described herein.

Any suitable programming language may be used in accordance with the various embodiments of the invention. For example, the programming language used may include assembly language, Ada, APL, Basic, C, C++, dBase, Forth, HTML, Android, iOS, .NET, Python, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

The software, hardware and services described herein may be provided utilizing one or more cloud service models, such as Software-as-a-Service (SaaS), Platform-as-a-Service (PaaS), Infrastructure-as-a-Service (IaaS), and Logging as a Service (LaaS), and/or using one or more deployment models such as public cloud, private cloud, hybrid cloud, and/or community cloud models.

In the system and method of exemplary embodiments of the invention, a variety of “user interfaces” may be utilized to allow a user to interface with the personal computing devices. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents. The specification and drawings are accordingly to be regarded as an illustrative rather than restrictive sense.

What is claimed is:

1. A computer-implemented system for measuring prediction model efficacy, the system comprising:
a database in communication with a network;
a processor in communication with the network, the processor being configured to:
retrieve a dataset from the database, the dataset including identifying information for a plurality of targets, one or more predicted actions, and completed actions for each of the plurality of targets,
associate each of the plurality of targets with the one or more predicted actions to create target-action pairs,
for each target-action pair, generate a champion score using a champion model,
for each target-action pair, generate a variation score using the champion model, wherein the variation score is selected from a distribution of scores existing within a first confidence interval,
for each target-action pair, generate a challenger score using a challenger model,
define a test group comprising one or more target-action pairs for which the variation score is within a second confidence interval of the challenger score,
define a control group comprising of one or more target-action pairs for which the variation score is within a third confidence interval of the champion score, and
select one of the champion model and challenger model based on an accuracy of the control group to the completed actions and an accuracy of the test group to the completed actions.

2. The computer-implemented system for measuring prediction model efficacy of claim 1, wherein the processor is further configured to select one of the champion model and challenger model based on a comparison of the accuracy of the control group to the completed actions and the accuracy of the test group to the completed actions.

3. The computer-implemented system for measuring prediction model efficacy of claim 1, wherein the processor is further configured to select the champion model when the control group is more accurate to the completed actions than the test group.

4. The computer-implemented system for measuring prediction model efficacy of claim 1, wherein the processor is further configured to select the challenger model when the test group is more accurate to the completed actions than the control group.

5. The computer-implemented system for measuring prediction model efficacy of claim 1, wherein the test group comprises of one or more target-action pairs for which the variation score and the champion score differ by a predetermined threshold or more.

6. The computer-implemented system for measuring prediction model efficacy of claim 5, wherein the control group comprises one or more target-action pairs for which the variation score and the challenger score differ by a second predetermined threshold or more.

7. The computer-implemented system for measuring prediction model efficacy of claim 1, wherein completed actions for each of the plurality of targets are measured over a predetermined time interval.

8. The computer-implemented system for measuring prediction model efficacy of claim 1, wherein the processor is further configured to determine an attribution amount for each of the variation scores on the completed actions using an attribution model.

9. The computer-implemented system for measuring prediction model efficacy of claim 1, wherein the processor is further configured to select one of the champion model and the challenger model based on the attribution amount.

10. The computer-implemented system for measuring prediction model efficacy of claim 1, wherein the processor is further configured to execute one of the champion model and challenger model based on a selection selected by the processor.

11. The computer-implemented system for measuring prediction model efficacy of claim 1, wherein the plurality of targets are a plurality of financial accounts.

12. The computer-implemented system for measuring prediction model efficacy of claim 11, wherein the one or more actions are predicted purchases of one or more financial instruments.

13. The computer-implemented system for measuring prediction model efficacy of claim 12, wherein the processor is further configured to output the variation scores at a user terminal.

14. The computer-implemented system for measuring prediction model efficacy of claim 11, wherein the completed actions are completed purchases of one or more financial instruments.

15. A method comprising:
retrieving a dataset from a database, the dataset including a plurality of targets, one or more prediction variables, and measured actions for each of the plurality of targets,
associating each of the plurality of targets with the one or more prediction variables to create target-variable pairs,
for each target-variable pair, generating a champion score using a champion model,
for each target-variable pair, generating a variation score using the champion model, wherein the variation score is selected from a distribution of scores generated by the champion model existing within a first confidence interval,
for each target-action pair, generating a challenger score using a challenger model,
defining a test group comprising one or more target-action pairs for which the variation score is within a second confidence interval of the challenger score,
defining a control group comprising of one or more target-action pairs for which the variation score is within a third confidence interval of the champion score,
selecting one of the champion model and challenger model based on an accuracy of the control group to the completed actions and an accuracy of the test group to the completed actions, and
executing, by a processor, one of the champion model and challenger model based on the selecting.

16. The method of claim 15, further comprising:
selecting the champion model when the control group is more accurate to the completed actions than the test group.

17. The method of claim 15, further comprising:
selecting the challenger model when the test group is more accurate to the completed actions than the control group.

18. The method of claim 15, wherein completed actions for each of the plurality of targets are measured over a predetermined time interval.

19. The method of claim 15, further comprising:
advising one or more clients to take predetermined actions based on the variation scores.

20. The method of claim 19, further comprising:
determining an attribution value of the variation scores based on the completed actions using an attribution model.
